(19) United States
(12) Patent Application Publication
(10) Pub. No.: US 2024/0264288 A1
(43) Pub. Date: Aug. 8, 2024

(54) TIME-OF-FLIGHT RANGING SYSTEM AND TIME-OF-FLIGHT RANGING METHOD

(71) Applicant: eYs3D Microelectronics, Co., Taipei City (TW)

(72) Inventor: Chi-Feng Lee, Taipei City (TW)

(73) Assignee: eYs3D Microelectronics, Co., Taipei City (TW)

(21) Appl. No.: 18/499,233

(22) Filed: Nov. 1, 2023

Related U.S. Application Data
(60) Provisional application No. 63/421,181, filed on Nov. 1, 2022.

(51) Int. Cl. G01S 7/4911; G01S 7/4915; G01S 17/32

(52) U.S. Cl. CPC G01S 7/4911; G01S 7/4915; G01S 17/32

(57) ABSTRACT

The invention provides a time-of-flight ranging system and a time-of-flight ranging method. The time-of-flight ranging system includes a time-of-flight ranging sensor, a decoder, a computing processor, and a fusion processor. The time-of-flight ranging sensor receives a first reflected light and a second reflected light reflected by a sensing target, and generates first raw data and second raw data according to the first reflected light. The decoder generates a first input according to the first raw data and generates a second input according to the second raw data. The computing processor generates a first output and a second output according to the first input and the second input. The fusion processor performs a weighted average operation according to a first amplitude, a second amplitude, the first output, and the second output to generate depth information.

### CROSS-REFERENCE TO RELATED APPLICATION

This application claims the priority benefit of U.S. provisional application Ser. No. 63/421,181, filed on Nov. 1, 2022. The entirety of the above-mentioned patent application is hereby incorporated by reference herein and made a part of this specification.

### FIELD OF THE INVENTION

The invention relates to a ranging technique, and in particular to a time-of-flight ranging system and a time-of-flight ranging method.

### DESCRIPTION OF RELATED ART

As time-of-flight (ToF) technique is used in more and more application fields (such as driving distance measurement or visual identification systems), the requirements for the accuracy of time-of-flight ranging are also increasing. In particular, for general indirect time-of-flight (indirect-ToF, I-ToF) ranging sensors, the effectiveness and accuracy of the phase unwrapping process are crucial to the performance of the time-of-flight ranging system. Therefore, how to calculate depth information correctly and efficiently is one of the current important topics in the art.

### SUMMARY OF THE INVENTION

A time-of-flight ranging system of the invention includes a time-of-flight ranging sensor, a decoder, a computing processor, and a fusion processor. The time-of-flight ranging sensor is configured to receive a first reflected light and a second reflected light reflected by a sensing target, and generate first raw data and second raw data according to the first reflected light. The decoder is coupled to the time-of-flight ranging sensor and configured to generate a first input according to the first raw data and generate a second input according to the second raw data. The computing processor is coupled to the decoder and configured to generate a first output and a second output according to the first input and the second input. The fusion processor is coupled to the computing processor and configured to perform a weighted average operation according to a first amplitude, a second amplitude, the first output, and the second output to generate depth information.

In an embodiment of the invention, the time-of-flight ranging system further includes a memory. The memory is coupled to the time-of-flight ranging sensor and the decoder and configured to temporarily store at least one of a plurality of phase sampling data of the first raw data and the second raw data respectively.

In an embodiment of the invention, the time-of-flight ranging sensor first temporarily stores at least one of the plurality of phase sampling data of the first raw data into a plurality of memory spaces of the memory, then the time-of-flight ranging sensor provides at least another one of the plurality of phase sampling data of the first raw data directly to the decoder, and the decoder reads at least one of the plurality of phase sampling data from the memory to generate the first input. The time-of-flight ranging sensor then first temporarily stores at least one of the plurality of phase sampling data of the second raw data into the plurality of memory spaces of the memory, then the time-of-flight ranging sensor provides at least another one of the plurality of phase sampling data of the second raw data directly to the decoder, and the decoder reads at least one of the plurality of phase sampling data from the memory to generate the second input.

In an embodiment of the invention, the memory includes a first set of memory space and a second set of memory space. The time-of-flight ranging sensor sequentially temporarily stores the plurality of phase sampling data of the first raw data and the second raw data respectively into the first set of memory space and the second set of memory space of the memory.

In an embodiment of the invention, the decoder reads the plurality of phase sampling data of the first raw data from the first set of memory space to generate the first input, and then reads the plurality of phase sampling data of the second raw data from the second set of memory space to generate the second input.

In an embodiment of the invention, the decoder reads the plurality of phase sampling data of the first raw data from the first set of memory space to generate the first input, and another decoder simultaneously reads the plurality of phase sampling data of the second raw data from the second set of memory space to generate the second input.

In an embodiment of the invention, the memory further includes a third set of memory space and a fourth set of memory space. During a period in which the plurality of phase sampling data temporarily stored in the first set of memory space and the second set of memory space are read out, the time-of-flight ranging sensor temporarily stores the plurality of phase sampling data respectively of the third raw data and the fourth raw data in the third set of memory space and the fourth set of memory space of the memory in sequence.

In an embodiment of the invention, the decoder reads the plurality of phase sampling data of the first raw data from the first set of memory space at a plurality of odd pixel clocks, and reads the plurality of phase sampling data of the second raw data from the second set of memory space at a plurality of even pixel clocks to generate the first input and the second input.

In an embodiment of the invention, the computing processor includes a first processor and a second processor. The first processor is coupled to the decoder and configured to generate a first intermediate variable and a second intermediate variable according to a plurality of parameters, the first input, and the second input. The second processor is coupled to the first processor and configured to generate the first output and the second output according to the first input, the second input, the first intermediate variable, and the second intermediate variable.

In an embodiment of the invention, the first processor multiplies the first input by the first parameter minus the second input multiplied by the second parameter, then performs a rounding operation and multiplied by a third parameter, and lastly performs a remainder operation by using a fourth parameter to generate the first intermediate variable. The first processor multiplies the first input by the first parameter minus the second input multiplied by the second parameter, then performs a rounding operation and multiplied by a fifth parameter, and lastly performs a remainder operation by using a sixth parameter to generate the second intermediate variable. The first parameter is a result of dividing a first preset parameter by a preset parameter. The second parameter is a result of dividing a second preset parameter by the preset parameter. The preset parameter is 2π.

In an embodiment of the invention, the fourth parameter is the second preset parameter. The sixth parameter is the first preset parameter. The third parameter is an integer value satisfying the first preset parameter multiplied by another integer value and added by 1 and then divided by the second preset parameter or a result thereof. The fifth parameter is a rounded down result of the third parameter multiplied by the second preset parameter and divided by the first preset parameter.

In an embodiment of the invention, the second processor multiplies the first intermediate variable by the preset parameter and then adds the first input to obtain the first output. The second processor multiplies the second intermediate variable by the preset parameter and then adds the second input to obtain the second output.

In an embodiment of the invention, the first processor multiplies the first input by the first parameter, subtracts the second input multiplied by the second parameter, and adds 2 to a power of P−1, and right shifts a numerical result by P bits, then multiplied by a third parameter and performs a remainder operation by using a fourth parameter to generate the first intermediate variable. P is a precision factor, the first processor multiplies the first input by the first parameter, subtracts the second input multiplied by the second parameter, and adds 2 to the power of P−1, and right shifts a numerical result by P bits, then multiplied by a fifth parameter and performs a remainder operation by using a sixth parameter to generate the second intermediate variable. The first parameter is a result of 2 to a power of Q multiplied by the first preset parameter, divided by a preset parameter and then subjected to a rounding operation. The second parameter is a result of 2 to the power of Q multiplied by the second preset parameter, divided by the preset parameter and then subjected to a rounding operation. P is equal to a result of Q plus one input precision, and P and Q are positive integers.

In an embodiment of the invention, the second processor multiplies the first intermediate variable by a rounding operation result of the preset parameter multiplied by 2 to a power S to obtain the first output, and the second processor multiplies the second intermediate variable by a rounding operation result of the preset parameter multiplied by 2 to the power S to obtain the second output. S is a positive integer.

In an embodiment of the invention, the first processor subtracts the second input from the first input, divided by the fifth parameter and performs rounding, then multiplies the first parameter and performs a remainder operation with the fourth parameter to generate the first intermediate variable. The first processor subtracts the second input from the first input then divided by the fifth parameter and performs rounding, and then multiplied by a third parameter and performs a remainder operation by using a second parameter to generate the second intermediate variable. The first parameter and the third parameter are respectively integers, and the second parameter and the fourth parameter are respectively co-prime preset parameters. The fifth parameter is a greatest common factor of the second parameter and the fourth parameter.

In an embodiment of the invention, the second processor multiplies the first intermediate variable by the second parameter, multiplies the preset parameter, and adds the first input to generate the first output. The second processor multiplies the second intermediate variable by the fourth parameter, multiplies the preset parameter, and adds the second input to generate the second output.

In an embodiment of the invention, the processor subtracts the first input and the second input and then multiplied by a fifth parameter, and adds 2 to a power of P−1, and right shifts a numerical result by P bits, then multiplied by a first parameter and performs a remainder operation by using a fourth parameter to generate the first intermediate variable. The processor subtracts the first input from the second input, multiplied by the fifth parameter, adds 2 to the power of P−1, and right shifts a numerical result by P bits, and then multiplied by a third parameter and performs a remainder operation by using a second parameter to generate the second intermediate variable. The fifth parameter is a result of dividing 2 to a power of P by the preset parameter and performing a remainder operation, and 2 to the power of P is significantly greater than the preset parameter.

In an embodiment of the invention, the time-of-flight ranging sensor is an indirect time-of-flight ranging sensor. The first reflected light and the second reflected light have different modulation frequencies.

In an embodiment of the invention, the computing processor is configured to generate a lookup table according to the first input, the second input, and a plurality of parameters and generates the first output and the second output by searching a lookup table.

A time-of-flight ranging method of the invention includes the following steps: receiving a first reflected light and a second reflected light reflected by a sensing target and generating first raw data and second raw data according to the first reflected light via a time-of-flight ranging sensor; generating a first input according to the first raw data and generating a second input according to the second raw data via a decoder; generating a first output and a second output according to the first input and the second input via a computing processor; and performing a weighted average operation according to a first amplitude, a second amplitude, the first output, and the second output via a fusion processor to generate depth information.

Based on the above, the time-of-flight ranging system and the time-of-flight ranging method of the invention may accurately and efficiently generate the depth information for the sensing results of the time-of-flight ranging sensor.

In order to make the aforementioned features and advantages of the disclosure more comprehensible, embodiments accompanied with figures are described in detail below.

### BRIEF DESCRIPTION OF THE DRAWINGS

FIG. 1 is a schematic diagram of a time-of-flight ranging system of an embodiment of the invention.

FIG. 2 is a flowchart of a time-of-flight ranging method of an embodiment of the invention.

FIG. 3 is a schematic diagram of data flow of an embodiment of the invention.

FIG. 4 is a timing diagram of the embodiment of FIG. 3 of the invention.

FIG. 5 is a schematic diagram of data flow of an embodiment of the invention.

FIG. 6 is a timing diagram of the embodiment of FIG. 5 of the invention.

FIG. 7 is a schematic diagram of data flow of an embodiment of the invention.

FIG. 8 is a timing diagram of the embodiment of FIG. 7 of the invention.

FIG. 9 is a schematic diagram of data access of an embodiment of the invention.

FIG. 10 is a schematic diagram of data access of an embodiment of the invention.

FIG. 11 is a schematic diagram of a computing processor of an embodiment of the invention.

FIG. 12A is a schematic diagram of the operation logic of a first processor of an embodiment of the invention.

FIG. 12B is a schematic diagram of the operation logic of a second processor of an embodiment of the invention.

FIG. 13A is a schematic diagram of the operation logic of a first processor of an embodiment of the invention.

FIG. 13B is a schematic diagram of the operation logic of a second processor of an embodiment of the invention.

FIG. 14 is a schematic diagram of the operation logic of a first processor of an embodiment of the invention.

FIG. 15A is a schematic diagram of the operation logic of a first processor of an embodiment of the invention.

FIG. 15B is a schematic diagram of the operation logic of a second processor of an embodiment of the invention.

FIG. 16 is a schematic diagram of the operation logic of a first processor of an embodiment of the invention.

FIG. 17 is a schematic diagram of the operation logic of a first processor of an embodiment of the invention.

FIG. 18 is a schematic diagram of a fusion processor of an embodiment of the invention.

### DESCRIPTION OF THE EMBODIMENTS

In order to make the content of the invention more comprehensible, the following specific embodiments are taken as examples in which the invention may actually be implemented. In addition, wherever possible, elements/members/steps adopting the same reference numerals in the drawings and embodiments represent the same or similar components.

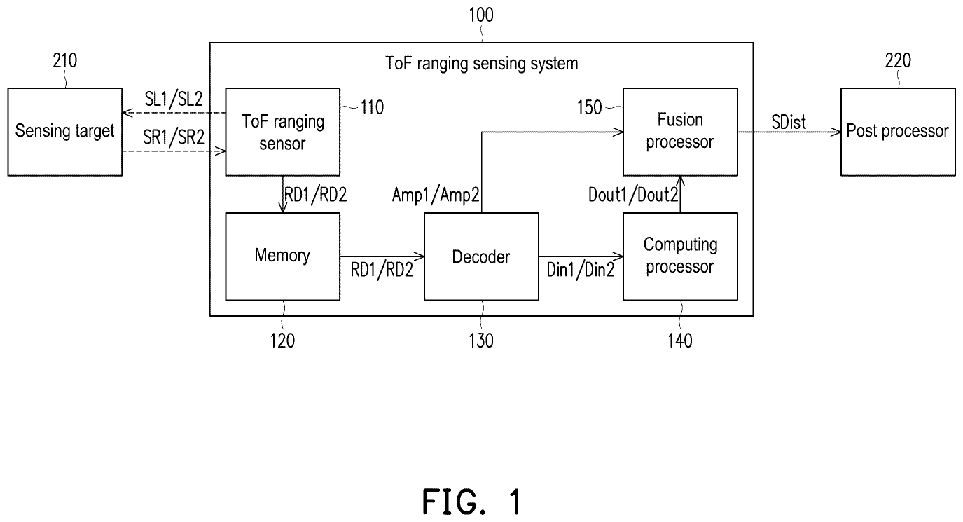

FIG. 1 is a schematic diagram of a time-of-flight ranging system of an embodiment of the invention. Referring to FIG. 1, a time-of-flight ranging system 100 includes a time-of-flight (ToF) ranging sensor 110, a memory 120, a decoder 130, a computing processor 140, and a fusion processor 150. The memory 120 is coupled to the time-of-flight ranging sensor 110 and the decoder 130. The decoder 130 is also coupled to the computing processor 140 and the fusion processor 150. The computing processor 140 is also coupled to the fusion processor 150. The fusion processor 150 is also coupled to a post processor 220. In the present embodiment, the time-of-flight ranging sensor 110 may be an indirect time-of-flight ranging sensor (Indirect-ToF, I-ToF). The time-of-flight ranging sensor 110 may further include a light-emitting element and a photosensitive element. The light-emitting element of the time-of-flight ranging sensor 110 is configured to sequentially emit a first sensing light SL1 and a second sensing light SL2 toward a sensing target 210, wherein the first sensing light SL1 and the second sensing light SL2 may have different modulation frequencies.

In the present embodiment, the photosensitive element of the time-of-flight ranging sensor 110 may receive a first reflected light SR1 and a second reflected light SR2 reflected by the sensing target 210 based on the first sensing light SL1 and the second sensing light SL2, wherein the first reflected light SR1 and the second reflected light SR2 may also have different modulation frequencies. In the present embodiment, the time of flight ranging system 100 may calculate depth information SDist between the time-of-flight ranging system 100 (or time-of-flight ranging sensor 110) to the sensing target 210 according to the raw data generated by receiving the first reflected light SR1 and the second reflected light SR2, and the depth information SDist may be provided to the post-processor 220 for subsequent applications, and the invention does not limit the application scenarios of the time-of-flight ranging system 100.

In the present embodiment, the memory 120 may include, for example, a static random-access memory (SRAM), a dynamic random-access memory (DRAM), a flash memory, or a non-volatile random-access memory (NVRAM). In the present embodiment, the decoder 130, the computing processor 140, and the fusion processor 150 may be implemented by software, or may be implemented by hardware, and may respectively include, for example, a central processing unit (CPU), a graphics processing unit (GPU), or other programmable general-purpose or special-purpose microprocessors, digital signal processors (DSP), programmable controllers, application-specific integrated circuits (ASIC), programmable logic devices (PLD), other similar processing units, or a combination of these units.

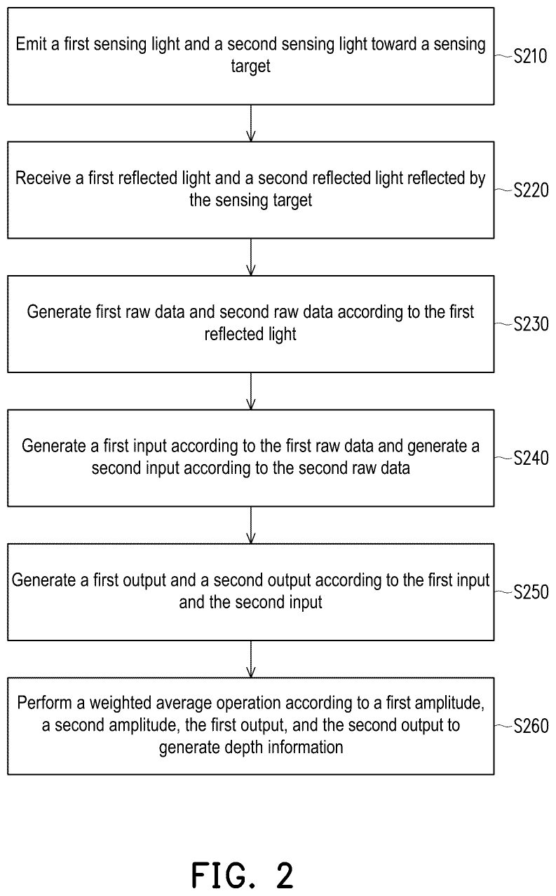

FIG. 2 is a flowchart of a time-of-flight ranging method of an embodiment of the invention. Referring to FIG. 1 and FIG. 2, the time-of-flight ranging system 100 may perform the following steps S210 to S260. In step S210, the time-of-flight ranging sensor 110 may emit the first sensing light SL1 and the second sensing light SL2 toward the sensing target 210. In step S220, the time-of-flight ranging sensor 110 may receive the first reflected light SR1 and the second reflected light SR2 reflected by the sensing target. Specifically, the time-of-flight ranging sensor 110 may first emit the first sensing light SL1 with a first modulation frequency to the sensing target 210 and receive the first reflected light SR1 reflected by the sensing target 210. Then, the time-of-flight ranging sensor 110 may emit the second sensing light SL2 with a second modulation frequency to the sensing target 210 and receive the second reflected light SR2 reflected by the sensing target 210.

In step S230, the time-of-flight ranging sensor 110 may generate first raw data RD1 and second raw data RD2 according to the first reflected light SR1 and the second reflected light SR2. In the present embodiment, the first raw data RD1 and the second raw data RD2 may respectively include a plurality of phase sampling data corresponding to different phases. Specifically, during one specific time period (such as a frame period or an image frame period) during which the first reflected light SR1 or the second reflected light SR2 is sensed, the time-of-flight ranging sensor 110 may generate N-phase shift exposure integrated data based on a plurality of phase shift exposures. Taking four-phase shift exposure integrated data (or quad data) as an example, the first raw data RD1 and the second raw data RD2 may respectively include first phase sampling data corresponding to a phase offset of 0 degrees, second phase sampling data corresponding to a phase offset of 90 degrees, third phase sampling data corresponding to a phase offset of 180 degrees, and fourth phase sampling data corresponding to a phase offset of 270 degrees. However, the invention is not limited to four-phase displacement exposure, and may be other multi-phase displacement exposures, for example.

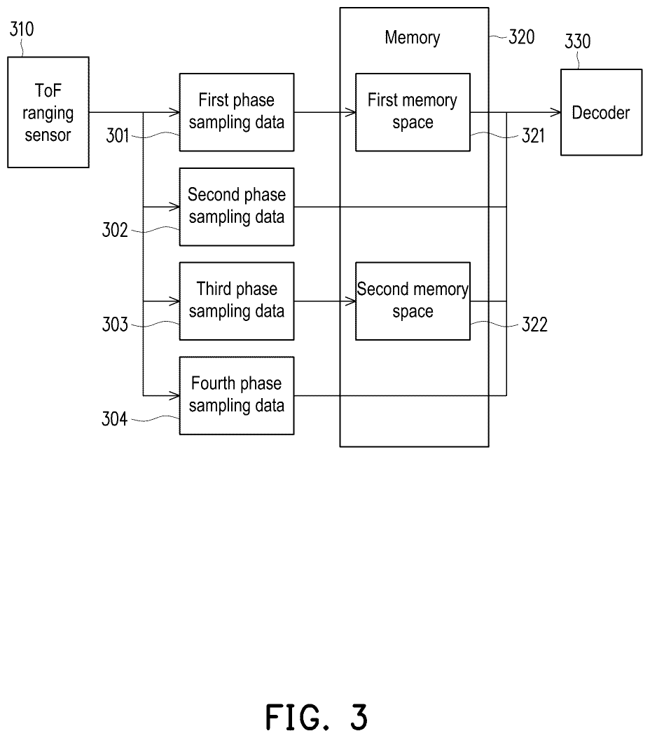

In the present embodiment, based on different data access architecture designs (such as the embodiments of FIG. 3 to FIG. 10 below), the time-of-flight ranging sensor 110 may output at least one of the plurality of phase sampling data of the first raw data RD1 and the second raw data RD2 to the memory 120, so that the memory 120 may temporarily store at least one of the plurality of phase sampling data respectively of the first raw data RD1 and the second raw data RD2. In the present embodiment, the decoder 130 may obtain the first raw data RD1 and the second raw data RD2 from the time-of-flight ranging sensor 110 and/or the memory 120.

In step S240, the decoder 130 may generate a first input Din1 according to the first raw data RD1 and generate a second input Din2 according to the second raw data RD2. The decoder 130 may convert the first raw data RD1 and the second raw data RD2 into corresponding phases. In the present embodiment, the decoder 130 may also generate a first amplitude Amp1 and a second input amplitude Amp2 according to the first raw data RD1 and the second raw data RD2. The decoder 130 may provide the first input Din1 and the second input Din2 to the computing processor 140, and may provide the first amplitude Amp1 and the second amplitude Amp2 to the fusion processor 150. In the present embodiment, the first amplitude Amp1 corresponds to the light intensity of the first reflected light SR1, and the second amplitude Amp2 corresponds to the light intensity of the second reflected light SR22.

In step S250, the computing processor 140 may generate a first output Dout1 and a second output Dout2 according to the first input Din1 and the second input Din2. In the present embodiment, the computing processor 140 may calculate the first output Dout1 and the second output Dout2 according to the first input Din1, the second input Din2, and a plurality of parameters by executing a plurality of computing logics, but the invention is not limited thereto. In an embodiment, the computing processor 140 may generate a lookup table according to the first input, the second input, and the plurality of parameters and generate the first output and the second output by searching a lookup table.

In step S260, the fusion processor 150 may perform a weighted average operation according to the first amplitude Amp1, the second amplitude Amp2, the first output Dout1, and the second output Dout2 to generate the depth information SDist. In the present embodiment, the fusion processor 150 may output the depth information SDist to the post-processor 220 so that the post-processor 220 may generate, for example, depth map data or point cloud data according to the depth information SDist, but the invention is not limited thereto. Therefore, the time-of-flight ranging system 100 of the present embodiment may achieve an effective ranging function.

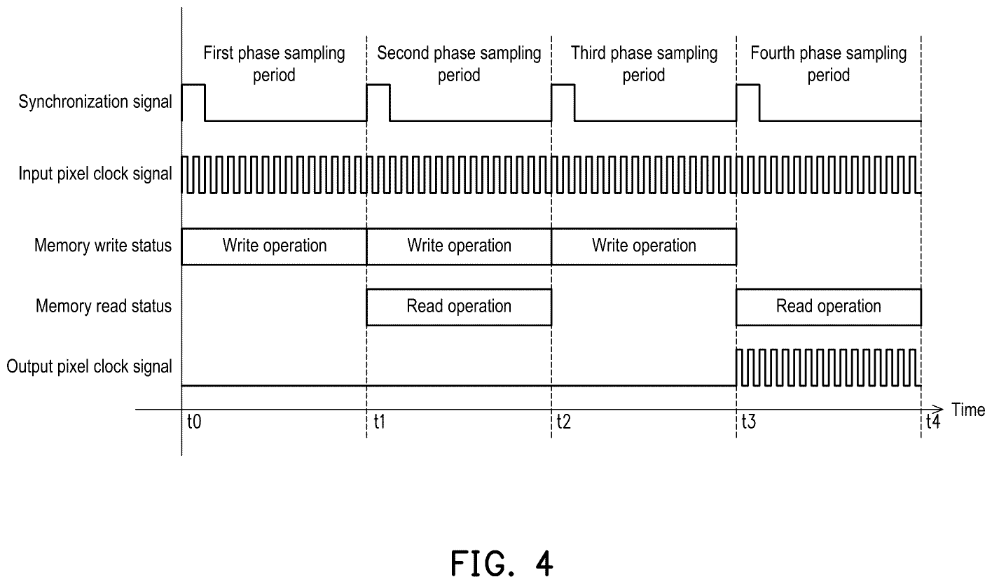

FIG. 3 is a schematic diagram of data flow of an embodiment of the invention. FIG. 4 is a timing diagram of the embodiment of FIG. 3 of the invention. Referring to FIG. 3, the configuration relationship between the time-of-flight ranging sensor 110, the memory 120, and the decoder 130 of FIG. 1 may implement a time-of-flight ranging sensor 310, a memory 320, and the decoder 330 as shown in FIG. 3. In the present embodiment, the time-of-flight ranging sensor 310 may generate first phase sampling data 301, second phase sampling data 302, third phase sampling data 303, and fourth phase sampling data 304 according to the first reflected light. The first phase sampling data 301, the second phase sampling data 302, the third phase sampling data 303, and the fourth phase sampling data 304 for example correspond to phase offsets of 0 degrees, 90 degrees, 180 degrees, and 270 degrees respectively, but the invention is not limited thereto.

Referring to FIG. 3 and FIG. 4, the period between the rising edges of two adjacent pulses of the synchronization signal is used as one phase sampling period. In the first period, the time-of-flight ranging sensor 310 may sample the first reflected light SR1 four times from time t0 to time t4. During the first phase sampling period from time t0 to time t1, the time-of-flight ranging sensor 310 may first temporarily store the first phase sampling data 301 of the first raw data into a memory space 321 of the memory 320. The memory 320 may perform a write operation. During the second phase sampling period from time t1 to time t2, the time-of-flight ranging sensor 310 may directly provide the second phase sampling data 302 of the first raw data to the decoder 330, and the decoder 330 reads the first phase sampling data 301 from the memory space 321 of the memory 320. The decoder 330 may perform an operation on the first phase sampling data 301 and the second phase sampling data 302 and store the operation results to the memory space 321 of the memory 320. In this regard, the memory 320 may perform a write operation and a read operation.

During the third phase sampling period from time t2 to time t3, the time-of-flight ranging sensor 310 may first temporarily store the third phase sampling data 303 of the first raw data into a memory space 322 of the memory 320. Accordingly, the memory 320 may perform a write operation. During the fourth phase sampling period from time t3 to time t4, the time-of-flight ranging sensor 310 may directly provide the fourth phase sampling data 304 of the first raw data to the decoder 330. The decoder 330 reads the previous operation result from the memory space 321 of the memory 320 and reads the third phase sampling data 303 from the memory space 322 of the memory 320. The decoder 330 may perform an operation on the previous operation result, the third phase sampling data 303, and the fourth phase sampling data 304 to generate a first input, and output the first input to the computing processor 340. Accordingly, the memory 320 may perform a read operation.

In the present embodiment, by inputting a pixel clock signal as shown in FIG. 4, the memory 320 may perform one pixel data write operation for each input pixel clock during the period from time t0 to time t3. Moreover, for the output pixel clock signal as shown in FIG. 4, the decoder 330 may perform one pixel data reading operation for each output pixel clock during the period from time t1 to time t2 and during the period from time t3 to time t4.

Moreover, during the second period, the time-of-flight ranging sensor 310 may sample the second reflected light SR2 four times, and also temporarily store a portion of the phase sampling data and intermediate calculation data by using the memory space 321 and the memory space 322 to be read by the decoder 330 to generate the second input Din2. Therefore, the memory 320 of the present embodiment may be configured with two memory spaces to temporarily store a portion of the phase sampling data. In other words, the decoder 330 may complete the decoding operation by using the memory spaces 321 and 322 of the memory 320 to efficiently generate the first input Din1 and the second input Din2.

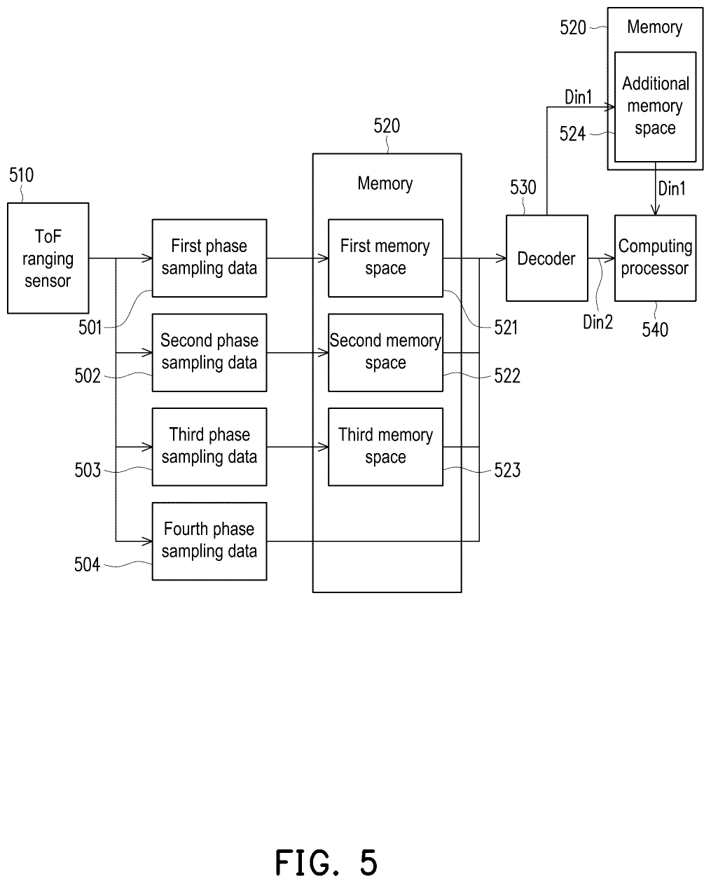

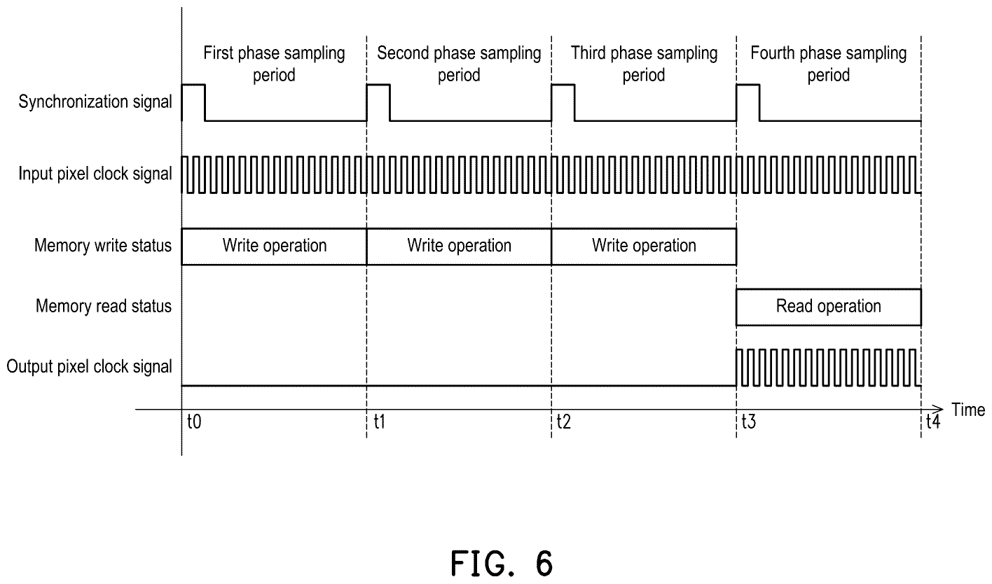

FIG. 5 is a schematic diagram of data access of an embodiment of the invention. FIG. 6 is a timing diagram of data access of the embodiment of FIG. 5 of the invention. Referring to FIG. 5, the configuration relationship between the time-of-flight ranging sensor 110, the memory 120, and the decoder 130 of FIG. 1 may implement a time-of-flight ranging sensor 510, a memory 520, and a decoder 530 as shown in FIG. 5. In the present embodiment, the time-of-flight ranging sensor 510 may generate first phase sampling data 501, second phase sampling data 502, third phase sampling data 503, and fourth phase sampling data 504 according to the first reflected light. The memory 520 may include memory spaces 521 to 523. In the present embodiment, the memory 520 may also include an additional memory space 524.

Referring to FIG. 5 and FIG. 6, the period between the rising edges of two adjacent pulses of the synchronization signal is used as one phase sampling period. In the first period, the time-of-flight ranging sensor may sample the first reflected light four times from time t0 to time t4. During the first phase sampling period from time t0 to time t1, the time-of-flight ranging sensor 510 may first temporarily store the first phase sampling data 501 of the first raw data into the memory space 521 of the memory 520. The memory 520 may perform a write operation. During the second phase sampling period from time t1 to time t2, the time-of-flight ranging sensor 110 may first temporarily store the second phase sampling data 502 of the first raw data into the memory space 522 of the memory 520. The memory 520 may perform a write operation.

During the third phase sampling period from time t2 to time t3, the time-of-flight ranging sensor 510 may first temporarily store the third phase sampling data 503 of the first raw data into the memory space 523 of the memory 520. The memory 520 may perform a write operation. During the fourth phase sampling period from time t3 to time t4, the time-of-flight ranging sensor 510 may directly provide the fourth phase sampling data 504 of the first raw data to the decoder 530. The decoder 530 reads the first phase sampling data 501, the second phase sampling data 502, and the third phase sampling data 503 from the memory spaces 521 to 523 of the memory 520. The decoder 530 may perform an operation on the first phase sampling data 501, the second phase sampling data 502, the third phase sampling data 503, and the fourth phase sampling data 504 to generate the first input Din1, and temporarily store the first input Din1 in the additional memory space 524 of the memory 520.

In the present embodiment, by inputting a pixel clock signal as shown in FIG. 6, the memory 520 may perform one pixel data write operation for each input pixel clock during the period from time t0 to time t3. Moreover, for the output pixel clock signal as shown in FIG. 6, the decoder 530 may perform three pixel data reading operations for each output pixel clock during the period from time t3 to time t4.

Moreover, during the second period, the time-of-flight ranging sensor 510 may sample the second reflected light four times, and also temporarily store a portion of the phase sampling data and intermediate calculation data by using the memory spaces 521 to 523 to be read by the decoder 530 to generate the second input Din2. Therefore, the computing processor 540 may obtain the first input Din1 from the additional memory space 524 of the memory 520 and obtain the second input Din2 from the decoder 530. The memory 520 of the present embodiment may be configured with two memory spaces to temporarily store a portion of the phase sampling data. In other words, the decoder 530 may complete the decoding operation by using the memory spaces 521 to 523 of the memory 520 to efficiently generate the first input Din1 and the second input Din2.

Specifically, in applications such as ToF dual frequency sensing or High Dynamic Range (HDR) detection, the time-of-flight ranging sensor may output a plurality of images corresponding to different conditions, wherein the different conditions refer to, for example, different modulation frequencies or different exposure time lengths. Accordingly, the additional memory space 524 of the memory 520 may store the phase or amplitude sensing results of the time-of-flight ranging sensor during the first period so that during the second period, the computing processor 540 may perform data processing and computing on the sensing result of the time-of-flight ranging sensor during the first period and the sensing result thereof during the second period. In addition, the architecture of FIG. 3 may also adopt the architecture of the additional memory space 524 of the memory 520 provided in the present embodiment to temporarily store the first input Din.

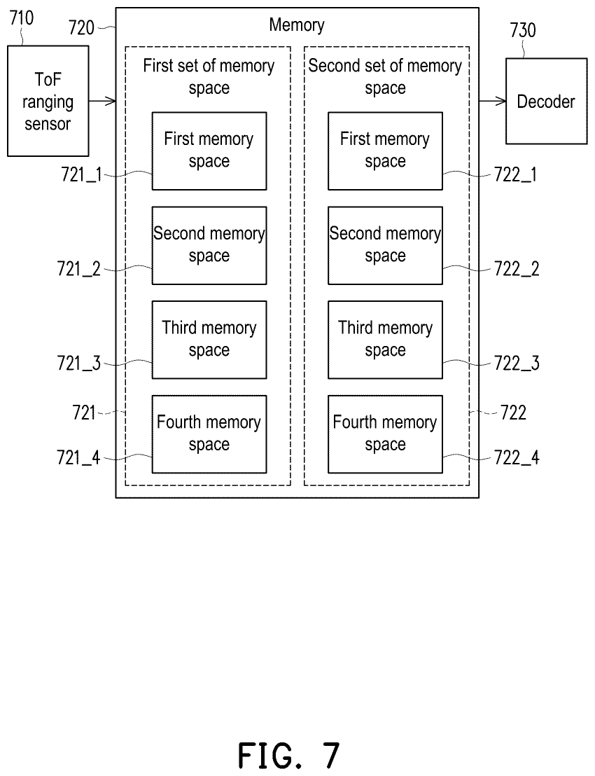

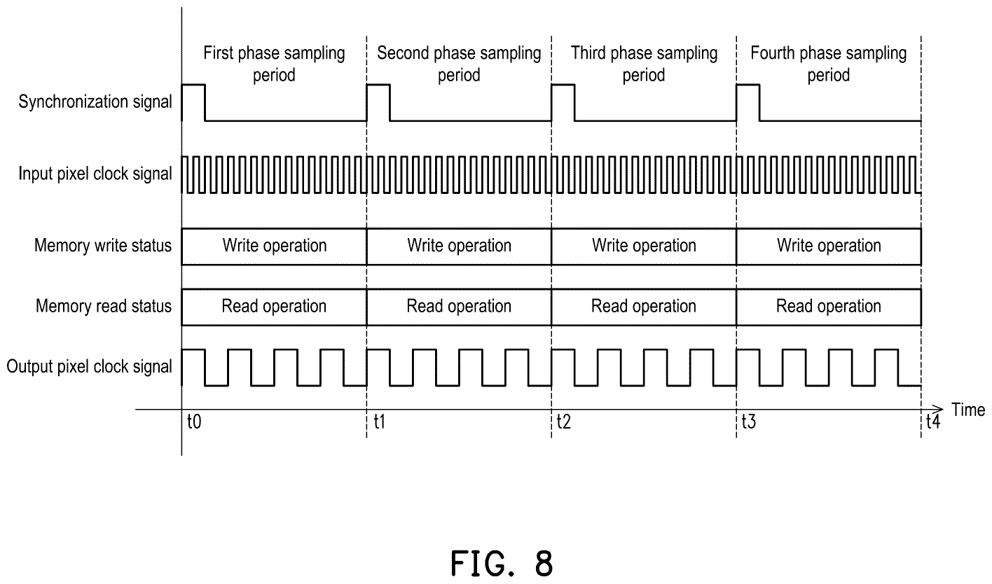

FIG. 7 is a schematic diagram of data access of an embodiment of the invention. FIG. 8 is a timing diagram of data access of the embodiment of FIG. 7 of the invention. Referring to FIG. 7, the configuration relationship between the time-of-flight ranging sensor 110, the memory 120, and the decoder 130 of FIG. 1 may implement a time-of-flight ranging sensor 710, a memory 720, and a decoder 730 as shown in FIG. 7. In the present embodiment, the memory 720 may include a first set of memory space 721 and a second set of memory space 722, wherein the first set of memory space 721 and the second set of memory space 722 may function as ping-pong buffers. The first set of memory space 721 may include a first memory space 721_1, a second memory space 721_2, a third memory space 721_3, and a fourth memory space 721_4. The second set of memory space 722 may include a first memory space 722_1, a second memory space 722_2, a third memory space 722_3, and a fourth memory space 722_4. In the present embodiment, the time-of-flight ranging sensor 710 may generate first phase sampling data, second phase sampling data, third phase sampling data, and fourth phase sampling data according to the first reflected light.

Referring to FIG. 7 and FIG. 8, the period between the rising edges of two adjacent pulses of the synchronization signal is used as one phase sampling period. In the first period, the time-of-flight ranging sensor 710 may sample the first reflected light four times from time t0 to time t4. During the first phase sampling period from time to to time t1, the time-of-flight ranging sensor 710 may first temporarily store the first phase sampling data of the first raw data into the first memory space 721_1 of the first set of memory space 721 of the memory 720. The memory 720 may perform a write operation. During the second phase sampling period from time t1 to time t2, the time-of-flight ranging sensor 710 may first temporarily store the second phase sampling data of the first raw data into the second memory space 721_2 of the first set of memory space 721 of the memory 720. The memory 720 may perform a write operation. During the third phase sampling period from time t2 to time t3, the time-of-flight ranging sensor 710 may first temporarily store the third phase sampling data of the first raw data into the third memory space 721_3 of the first set of memory space 721 of the memory 720. The memory 720 may perform a write operation. During the fourth phase sampling period from time t3 to time t4, the time-of-flight ranging sensor 710 may first temporarily store the fourth phase sampling data of the first raw data into the fourth memory space 721_4 of the first set of memory space 721 of the memory 720. The memory 720 may perform a write operation. Moreover, during the period from time t0 to time t4, the decoder 730 may simultaneously read the previous phase sampling data temporarily stored in the first memory space 722_1, the second memory space 722_2, the third memory space 722_3, and the fourth memory space 722_4 of the second set of memory space 722 to generate input corresponding to the previous sample. Therefore, the decoder 730 may utilize the first set of memory space 721 and the second set of memory space 722 of the ping-pong buffer architecture of the memory 720 to perform decoding, so that the computing processor 740 may efficiently read data from the decoder 730.

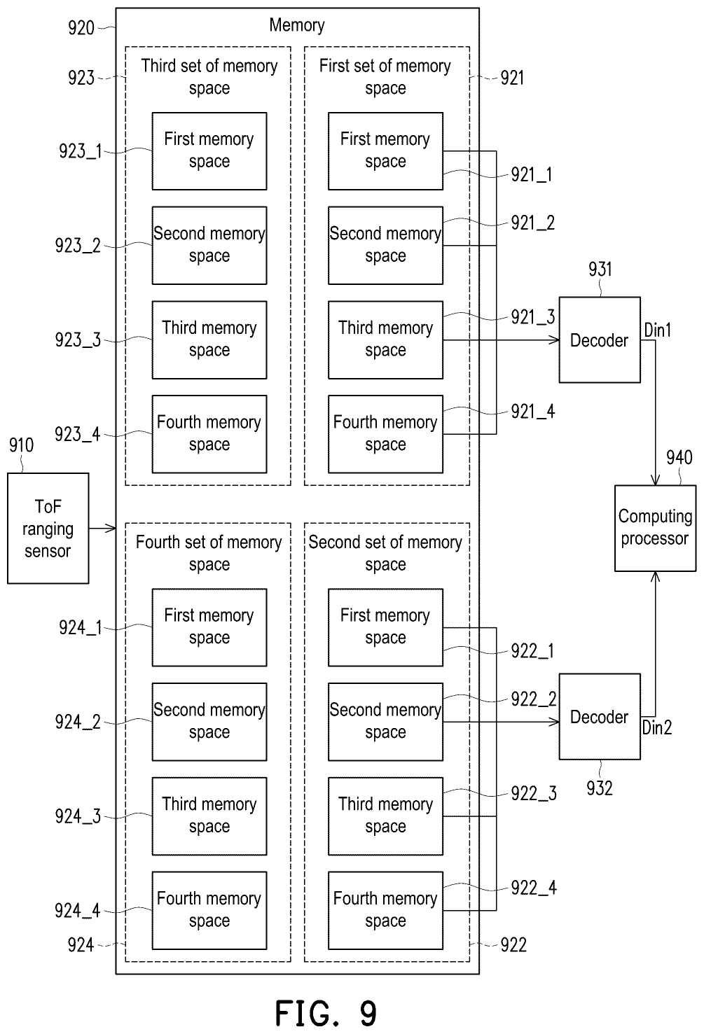

Moreover, in an embodiment, the memory 720 may further include a third set of memory space and a fourth set of memory space (the first to fourth memory spaces as shown in FIG. 9), so that the additional memory space architecture as shown in FIG. 5 may be adopted to implement dual-band data access operation. In the present embodiment, by inputting a pixel clock signal as shown in FIG. 8, the memory 720 may perform one pixel data write operation for each input pixel clock during the period from time t0 to time t4. Moreover, for the output pixel clock signal as shown in FIG. 8, the decoder 730 may perform one pixel data reading operation for each input pixel clock during the period from time t0 to time t4. Moreover, since the decoder 730 may read four pixel data of four memory spaces in the same set of memory space at the same time, one output pixel clock signal of the present embodiment may be equal to the time length of four input pixel clock signals, but the invention is not limited thereto.

FIG. 9 is a schematic diagram of data access of an embodiment of the invention. Referring to FIG. 9, the configuration relationship between the time-of-flight ranging sensor 110, the memory 120, the decoder 130, and the computing processor 140 of FIG. 1 may implement a time-of-flight ranging sensor 910, a memory 920, decoders 931 and 932, and a computing processor 940 as shown in FIG. 9. In the present embodiment, the memory 920 may include a first set of memory space 921, a second set of memory space 922, a third set of memory space 923, and a fourth set of memory space 924, wherein the first set of memory space 921, the second set of memory space 922, the third set of memory space 923, and the fourth set of memory space 924 may function as ping-pong buffers. The first set of memory space 921 may include a first memory space 921_1, a second memory space 921_2, a third memory space 921_3, and a fourth memory space 921_4. The second set of memory space 922 may include a first memory space 922_1, a second memory space 922_2, a third memory space 922_3, and a fourth memory space 922_4. The third set of memory space 923 may include a first memory space 923_1, a second memory space 923_2, a third memory space 923_3, and a fourth memory space 923_4. The fourth set of memory space 924 may include a first memory space 924_1, a second memory space 924_2, a third memory space 924_3, and a fourth memory space 924_4.

In the present embodiment, during the first period, the time-of-flight ranging sensor 910 may generate first phase sampling data, second phase sampling data, third phase sampling data, and fourth phase sampling data of the first raw data according to the first reflected light, and temporarily store them in the first memory space 921_1, the second memory space 921_2, the third memory space 921_3, and the fourth memory space 921_4 of the first set of memory space 921 in sequence. Then, during the second period, the time-of-flight ranging sensor 910 may generate first phase sampling data, second phase sampling data, third phase sampling data, and fourth phase sampling data of the second raw data according to the second reflected light, and temporarily store them in the first memory space 922_1, the second memory space 922_2, the third memory space 922_3, and the fourth memory space 922_4 of the second set of memory space 922 in sequence.

Then, during the period in which the plurality of phase sampling data during the first period and the second period temporarily stored in the first set of memory space 921 and the second set of memory space 922 are read out, the time-of-flight ranging sensor 910 may temporarily store the plurality of phase sampling data respectively of the third raw data during the third period and the fourth raw data during the fourth period to the third set of memory space 923 and the fourth set of memory space 924. In the present embodiment, the decoder 931 may read the plurality of phase sampling data of the first raw data temporarily stored in the first set of memory space 921 to generate the first input Din1, and at the same time, the decoder 932 may read the plurality of phase sampling data of the second raw data temporarily stored in the second set of memory space 922 to generate the second input Din2. The decoder 931 and the decoder 932 may provide the first input Din1 and the second input Din2 to the computing processor 940 at the same time. In other words, in the present embodiment, the first input Din1 and the second input Din2 may be efficiently generated by increasing the memory space of the memory 920 and by using two decoders to complete the decoding operation in parallel.

Moreover, in an embodiment, the decoder 931 and the decoder 932 may also be implemented by one decoder to sequentially read the data in the first set of memory space 921 and the second set of memory space 922, and sequentially provide the first input Din1 and the second input Din2 to the computing processor 940.

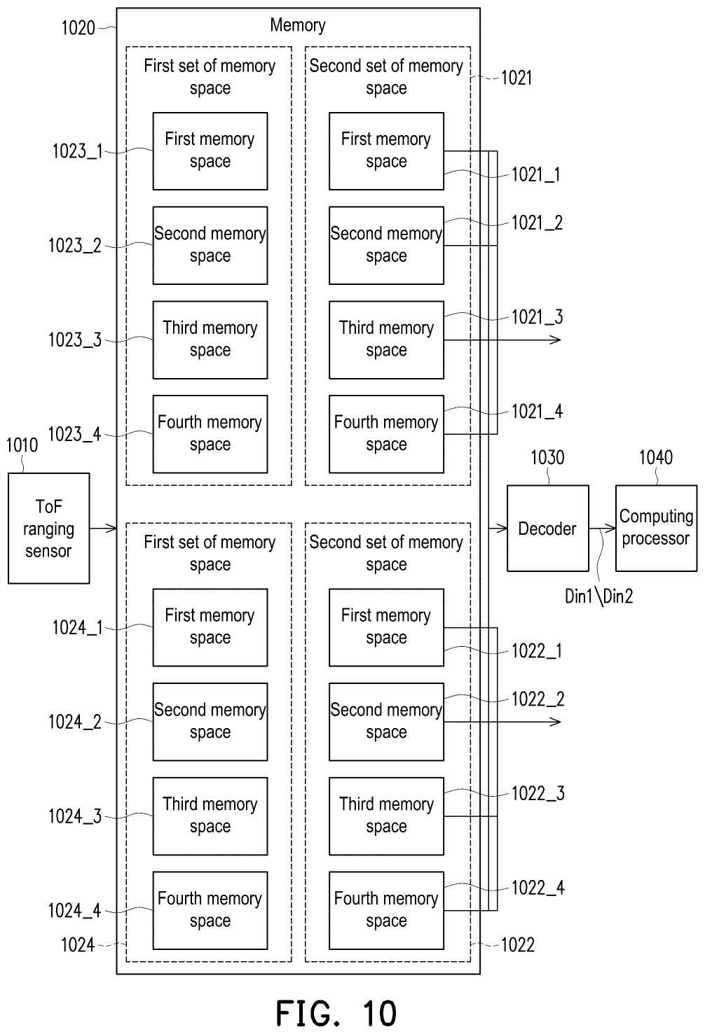

FIG. 10 is a schematic diagram of data access of an embodiment of the invention. Referring to FIG. 10, the configuration relationship between the time-of-flight ranging sensor 110, the memory 120, the decoder 130, and the computing processor 140 of FIG. 1 may implement a time-of-flight ranging sensor 1010, a memory 1020, decoders 1031 and 1032, and a computing processor 1040 as shown in FIG. 10. In the present embodiment, the memory 1020 may include a first set of memory space 1021, a second set of memory space 1022, a third set of memory space 1023, and a fourth set of memory space 1024, wherein the first set of memory space 1021, the second set of memory space 1022, the third set of memory space 1023, and the fourth set of memory space 1024 may function as ping-pong buffers. The first set of memory space 1021 may include a first memory space 1021_1, a second memory space 1021_2, a third memory space 1021_3, and a fourth memory space 1021_4. The second set of memory space 1022 may include a first memory space 1022_1, a second memory space 1022_2, a third memory space 1022_3, and a fourth memory space 1022_4. The third set of memory space 1023 may include a first memory space 1023_1, a second memory space 1023_2, a third memory space 1023_3, and a fourth memory space 1023_4. The fourth set of memory space 1024 may include a first memory space 1024_1, a second memory space 1024_2, a third memory space 1024_3, and a fourth memory space 1024_4.

In the present embodiment, during the first period, the time-of-flight ranging sensor 1010 may generate first phase sampling data, second phase sampling data, third phase sampling data, and fourth phase sampling data of the first raw data according to the first reflected light, and temporarily store them in the first memory space 1021_1, the second memory space 1021_2, the third memory space 1021_3, and the fourth memory space 1021_4 of the first set of memory space 1021 in sequence. Then, during the second period, the time-of-flight ranging sensor 1010 may generate first phase sampling data, second phase sampling data, third phase sampling data, and fourth phase sampling data of the second raw data according to the second reflected light, and temporarily store them in the first memory space 1022_1, the second memory space 1022_2, the third memory space 1022_3, and the fourth memory space 1022_4 of the second set of memory space 1022 in sequence.

Then, during the period when the plurality of phase sampling data temporarily stored in the first set of memory space 1021 and the second set of memory space 1022 are read out, the time-of-flight ranging sensor 1010 may temporarily store the plurality of phase sampling data respectively of the third raw data and the fourth raw data to the third set of memory space 1023 and the fourth set of memory space 1024. In the present embodiment, the decoder 1030 can, for example, read the plurality of phase sampling data of the first raw data from the first set of memory space 1021 at a plurality of odd pixel clocks, and, for example, read the plurality of phase sampling data of the second raw data from the second set of memory space 1022 at a plurality of even pixel clocks to generate the first input Din1 and the second input Din2. The decoder 1030 may provide the first input Din1 and the second input Din2 to the computing processor 1040 in sequence. In other words, in the present embodiment, the decoding operation may be completed by increasing the memory space of the memory 1020, so as to efficiently generate the first input Din1 and the second input Din2 in an interleaved manner under different output pixel clocks.

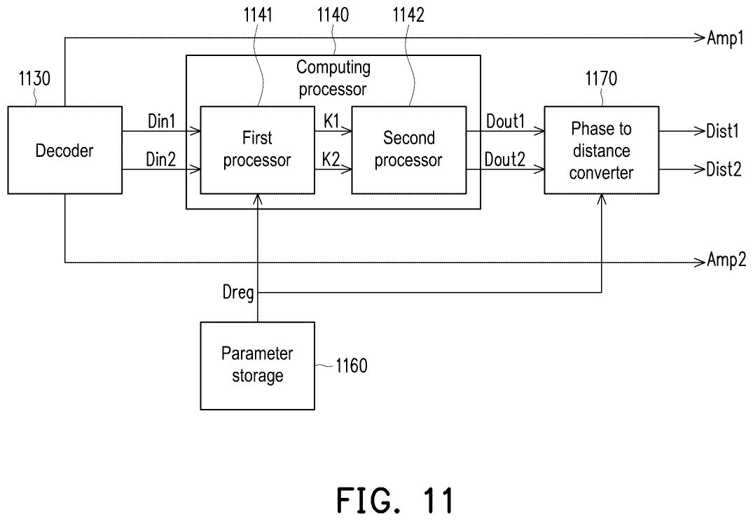

FIG. 11 is a schematic diagram of a computing processor of an embodiment of the invention. Referring to FIG. 11, the decoder 130 and the computing processor 140 of FIG. 1 may be implemented by the architecture of the decoder 1130 and the computing processor 1140 of FIG. 11, and the time-of-flight ranging system 100 of FIG. 1 may also include a parameter storage 1160 and a phase-to-distance converter 1170, wherein the parameter storage 1160 may be a non-volatile memory such as flash memory or a hard disk. In the present embodiment, the computing processor 1140 may be a dual processor. The computing processor 1140 may include a first processor 1141 and a second processor 1142. The first processor 1141 is coupled to the decoder 1130 and the second processor 1142. The second processor 1142 is also coupled to the phase-to-distance converter 1170.

In the present embodiment, the decoder 1130 may obtain the first raw data and the second raw data in the data access manner of the embodiments of FIG. 3 to FIG. 10, and generate the first input Din1, the second input Din2, the first amplitude Amp1, and the second amplitude Amp2 according to the first raw data and the second raw data. The first processor 1141 may generate a first intermediate variable K1 and a second intermediate variable K2 according to a plurality of parameters Dreg, the first input Din1, and the second input Din2. The second processor 1142 may generate the first output Dout1 and the second output Dout2 according to the first input Din1, the second input Din2, the first intermediate variable K1, and the second intermediate variable K2. In the present embodiment, the plurality of parameters Dreg may be temporarily stored in the parameter storage 1160.

In the present embodiment, the first output Dout1 and the second output Dout2 generated by the second processor 1142 may be phases, and the phase-to-distance converter 1170 may convert the first output Dout1 and the second output Dout2 into first depth information Dist1 and second depth information Dist2. In an embodiment, the first output Dout1 and the second output Dout2 generated by the second processor 1142 may also directly be depth information, so the phase-to-distance converter 1170 may be omitted.

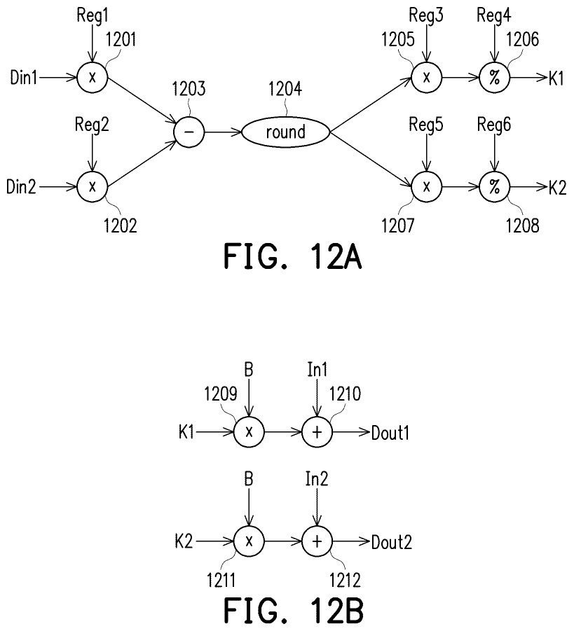

FIG. 12A is a schematic diagram of the operation logic of a first processor of an embodiment of the invention. FIG. 12B is a schematic diagram of the operation logic of a second processor of an embodiment of the invention. Referring to FIG. 11, FIG. 12A, and FIG. 12B, the present embodiment provides a computing logic suitable for performing a floating point operation. It should be noted that in the present embodiment, the first input Din1 and the second input Din2 may be phases, and the first input Din1, the second input Din2, the first output Dout1, and the second output Dout2 may satisfy the following formula (1) and formula (2), wherein a preset parameter B, a first preset parameter N1, and a second preset parameter M1 may be determined according to system or sensor characteristics or set by the user.

$$D out 1 = K 1 \times B + Din 1 \qquad formula ( 1 )$$

$$D out 2 = D out 1 \times N 1 / M 1 = K 2 \times B + Din 2 \qquad formula ( 2 )$$

Referring first to FIG. 11 and FIG. 12A, the first processor 1141 of FIG. 11 may perform a floating point operation and may implement the computing logic of FIG. 12A. In the present embodiment, the first processor 1141 may include multipliers 1201, 1202, 1205, 1207, a subtractor 1203, a rounding operator 1204, and remainder operators 1206 and 1208. The multipliers 1201, 1202, 1205, and 1207, the subtractor 1203, the rounding operator 1204, and the remainder operators 1206 and 1208 may be implemented by related logic circuits and/or related computing algorithms, and the invention is not limited thereto.

In the present embodiment, in order to calculate the first intermediate variable K1 and the second intermediate variable K2, the first processor 1141 may execute the following computing logic. The first processor 1141 may multiply the first input Din1 by a first parameter Reg1 via the multiplier 1201, and may multiply the second input Din2 by a second parameter Reg2 via the multiplier 1202. The first processor 1141 may subtract the operation results of the multiplier 1201 and the multiplier 1202 via the subtractor 1203. Then, the first processor 1141 may perform a rounding operation on the operation result of the subtractor 1203 via the rounding operator 1204 and provide to the multipliers 1205 and 1207. Then, the first processor 1141 may multiply the operation result of the rounding operator 1204 by a second parameter Reg3 via the multiplier 1205, and perform a remainder operation on the operation result of the multiplier 1205 by using a fourth parameter Reg4 via the remainder operator 1206 to generate the first intermediate variable K1. The first processor 1141 may multiply the operation result of the rounding operator 1204 by a fifth parameter Reg5 via the multiplier 1207, and perform a remainder operation on the operation result of the multiplier 1207 by using a sixth parameter Reg6 via the remainder operator 1208 to generate the second intermediate variable K2.

In the present embodiment, the first parameter Reg1 is the result of dividing the first preset parameter N1 by the preset parameter B (Reg1=N1/B), and the second parameter Reg2 is the result of dividing the second preset parameter M1 by the preset parameter B (Reg2=M1/B), wherein the preset parameter may be 2π. The third parameter Reg3 may satisfy the first preset parameter N1 multiplied by an integer value k and added by 1 and then divided by the second preset parameter M1, that is, the smallest possible result of bringing any integer k into (N1*k+1)/M1 for an integer value. The fourth parameter Reg4 may be equal to the second preset parameter M1. The fifth parameter Reg5 may be equal to a rounded down result of multiplying the third parameter Reg3 by the second preset parameter M1 and divided by the first preset parameter N1 (Reg5=floor(Reg3*M/N)). The sixth parameter Reg6 may be equal to the first preset parameter N1. In the present embodiment, the plurality of parameters Dreg stored in the parameter storage 1160 may include the first parameter Reg1 to the sixth parameter Reg6, the preset parameter B, the first preset parameter N1, and the second preset parameter M1 used in the present embodiment.

Then, referring to FIG. 11 and FIG. 12B, the second processor 1142 of FIG. 11 may perform a floating point operation and may implement the computing logic of FIG. 12B. In the present embodiment, the second processor 1142 may include multipliers 1209 and 1211 and adders 1210 and 1212. The multipliers 1209 and 1211 and the adders 1210 and 1212 may be implemented by related logic circuits and/or related computing algorithms, and the invention is not limited thereto.

In the present embodiment, in order to calculate the first output Dout1 and the second output Dout2, the second processor 1142 may execute the following computing logic. The second processor 1142 may multiply the first intermediate variable K1 by the preset parameter B via the multiplier 1209, and add the operation result of the multiplier 1209 to the first input Din1 via the adder 1210 to obtain the first output Dout1. The second processor 1142 may multiply the second intermediate variable K2 by the preset parameter B via the multiplier 1211, and add the operation result of the multiplier 1211 to the second input Din2 via the adder 1212 to obtain the second output Dout2.

More specifically, the embodiments of FIG. 11 to FIG. 14 may be applied to time-of-flight dual frequency sensing (ToF dual frequency sensing). In the above embodiment, the preset parameter B is equal to 2*π, wherein π is pi. In the above embodiment, the ratio of N/M may be the ratio of the modulation frequencies of the first reflected light and the second reflected light, but the invention is not limited thereto. Formula (1) may perform phase unwrapping on the first input Din1 to generate a new unwrapping phase value, that is, the first output Dout1. Moreover, formula (2) may unpack the second input Din2 to generate a new unwrapped phase value, that is, the second output Dout2. In this way, the phase-to-distance converter 1170 may convert the first output Dout1 and the second output Dout2 into the first depth information Dist1 and the second depth information Dist2 by using a phase-to-distance function. In this way, the fusion processor 150 of FIG. 1 may combine the first depth information Dist1 and the second depth information Dist2 via a fusion function (such as a weighted average operation function) to obtain accurate and unwrapped distance measurements.

For example, the following derivation uses simple numerical values as examples. In the absence of noise, it is assumed that the first input Din1 is equal to 4. The second input Din2 is equal to 2. The preset parameter B is equal to 5. The first preset parameter N1 is equal to 4. The second preset parameter M1 is equal to 3. Moreover, the first parameter Reg1 is 0.8 (N/B=4/5). The second parameter Reg2 is 0.6(M/B=3/5). The third parameter Reg3 is 2 (precalculated and configured by the user or the system). The fourth parameter Reg4 is 3(M). The fifth parameter Reg5 is 3 (precalculated and configured by the user or the system). The sixth parameter Reg4 is 4(M). Therefore, the first processor 1141 may calculate the first intermediate variable K1 is equal to 1 (K1=round(4×0.8−2×0.6)×2%3=1), and may calculate the second intermediate variable K2 is equal to 2 (K2=round(4×0.8−2×0.6)×3%4=2). Moreover, the second processor 1142 may calculate the first output Dout1 is equal to 9 (Dout1=K1×B+Din1=1×5+4−9), and the second output Dout2 is equal to 12 (Dout2=K2×B+Din2=2×5+2=12), wherein the symbol “%” in the mathematical formulas represents the operation of finding the remainder.

As another example, the following derivation uses simple numerical values as examples. In the presence of noise, it is assumed that the first input Din1 is equal to 4.1. The second input Din2 is equal to 1.9. The preset parameter B is equal to 5. The first preset parameter N1 is equal to 4. The second preset parameter M1 is equal to 3. Moreover, the first parameter Reg1 is 0.8 (N/B=4/5). The second parameter Reg2 is 0.6(M/B=3/5). The third parameter Reg3 is 2 (precalculated and configured by the user or the system). The fourth parameter Reg4 is 3(M). The fifth parameter Reg5 is 3 (precalculated and configured by the user or the system). The sixth parameter Reg4 is 4(M). Therefore, the first processor 1141 may calculate the first intermediate variable K1 is equal to 1 (K1=round(4.1×0.8−1.9×0.6)×2%3=1), and may calculate the second intermediate variable K2 is equal to 2 (K2=round(4×0.8−2×0.6)×3%4=2). Moreover, the second processor 1142 may calculate the first output Dout1 is equal to 9 (Dout1=K1×B+Din1=1×5+4.1=9.1), and the second output Dout2 is equal to 12 (Dout2=K2×B+Din2=2×5+1.9=11.9), wherein the symbol “%” in the mathematical formulas represents the operation of finding the remainder.

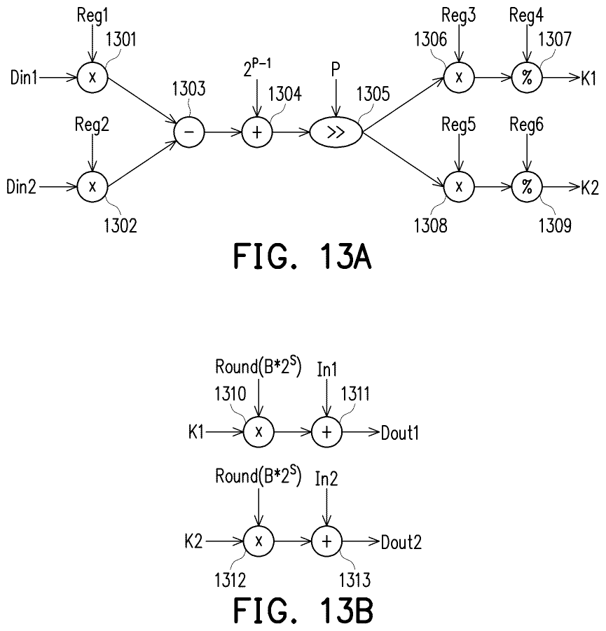

FIG. 13A is a schematic diagram of the operation logic of a first processor of an embodiment of the invention. Referring to FIG. 11, FIG. 13A, and FIG. 13B, the present embodiment provides a computing logic suitable for performing a fixed point operation. It should be noted first that in the present embodiment, the first input Din1 and the second input Din2 may be phase parameters, and the first input Din1, the second input Din2, the first output Dout1, and the second output Dout2 may satisfy formula (1) and formula (2).

Referring first to FIG. 11 and FIG. 13A, the first processor 1141 of FIG. 11 may perform a fixed point operation and may implement the computing logic of FIG. 13A. In the present embodiment, the first processor 1141 may include multipliers 1301, 1302, 1306, 1308, a subtractor 1303, an adder 1304, a right shift operator 1305, and remainder operators 1307 and 1309. The multipliers 1301, 1302, 1306, 1308, the subtractor 1303, the adder 1304, the right shift operator 1305, and the remainder operators 1307 and 1309 may be implemented by related logic circuits and/or related computing algorithms, and the invention is not limited thereto.

In the present embodiment, in order to calculate the first intermediate variable K1 and the second intermediate variable K2, the first processor 1141 may execute the following computing logic. The first processor 1141 may multiply the first input Din1 by the first parameter Reg1 via the multiplier 1301, and the first processor 1141 may multiply the second input Din2 by the second parameter Reg2 via the multiplier 1302. The first processor 1141 may perform a subtraction operation on the operation results of the multiplier 1301 and the multiplier 1302 via the subtractor 1303. Then, the first processor 1141 may add the operation result of the subtractor 1303 to 2 to the power of P−1 via the adder 1304. The first processor 1141 may right shift the operation result of the adder 1304 by P bits via the right shift operator 1305. Then, the first processor 1141 may multiply the operation result of the right shift operator 1305 by the third parameter Reg3 via the multiplier 1306, and perform a remainder operation on the operation result of the multiplier 1306 by using the fourth parameter Reg4 via the remainder operator 1307 to generate the first intermediate variable K1. Moreover, the first processor 1141 may multiply the operation result of the right shift operator 1305 by the fifth parameter Reg5 via the multiplier 1308, and perform a remainder operation on the operation result of the multiplier 1308 by using the sixth parameter Reg6 via the remainder operator 1309 to generate the second intermediate variable K2.

In the present embodiment, the first parameter Reg1 is a result of 2 to the power of Q multiplied by the first preset parameter N1, divided by the preset parameter B and then subjected to a rounding operation (Reg1=round(2^{Q}*N1/B)). The second parameter is a result of 2 to the power of Q multiplied by the second preset parameter M1, divided by the preset parameter B and then subjected to a rounding operation (Reg2=round(2^{Q}*M1/B)). In the present embodiment, the parameter P is equal to the result of the parameter Q plus the input precision (P=Q+bit precision of input(S)). The parameter P and the parameter Q are positive integers. The greater the parameter P and the parameter Q, the higher the accuracy and the higher the hardware cost. The third parameter Reg3 may satisfy the first preset parameter N1 multiplied by the integer value k and added by 1 and then divided by the second preset parameter M1, that is, the smallest possible result of bringing any integer k into (N1*k+1)/M1 for an integer. The fourth parameter Reg4 may be equal to the second preset parameter M1. The fifth parameter Reg5 may be equal to a rounded down result of the third parameter Reg3 multiplied by the second preset parameter M1 and divided by the first preset parameter N1 (Reg5=floor(Reg3*M1/N1)). The sixth parameter Reg6 may be equal to the first preset parameter N1. In the present embodiment, the plurality of parameters Dreg stored in the parameter storage 1160 may include the first parameter Reg1 to the sixth parameter Reg6, the preset parameter B, the first preset parameter N1, and the second preset parameter M1 used in the present embodiment.

FIG. 13B is a schematic diagram of the operation logic of a second processor of an embodiment of the invention. The second processor 1142 of FIG. 11 may perform a fixed point operation and may implement the computing logic of FIG. 13B. In the present embodiment, the second processor 1142 may include multipliers 1310 and 1312 and adders 1311 and 1313. The multipliers 1310 and 1312 and the adders 1311 and 1313 may be implemented by related logic circuits and/or related computing algorithms, and the invention is not limited thereto.

In the present embodiment, in order to calculate the first output Dout1 and the second output Dout2, the second processor 1142 may execute the following computing logic. The second processor 1142 may multiply the first intermediate variable K1 by the preset parameter B multiplied by the rounding operation result of 2 to the power of S (Round(B*2^{S})) via the multiplier 1310, and the second processor 1142 may add the operation result of the multiplier 1310 to the first input Din1 via the adder 1311 to obtain the first output Dout1. The second processor 1142 may multiply the second intermediate variable K2 by the preset parameter B multiplied by the rounding operation result of 2 to the power of S (Round(B*2^{S})) via the multiplier 1312, and the second processor 1142 may add the operation result of the multiplier 1312 to the second input Din2 via the adder 1313 to obtain the second output Dout2. The parameter S may be a positive integer.

FIG. 14 is a schematic diagram of the operation logic of a first processor of an embodiment of the invention. Referring to FIG. 11 and FIG. 14, the present embodiment provides another computing logic suitable for performing fixed point computing. Accordingly, the first processor 1141 of FIG. 11 may perform a fixed point operation and may implement the computing logic of FIG. 14. In the present embodiment, the first processor 1141 may include multipliers 1401, 1402, 1407, and 1409, a subtractor 1403, a divider 1404, an adder 1405, a right shift operator 1406, and remainder operators 1408 and 1410. The multipliers 1401, 1402, 1407, and 1409, the subtractor 1403, the divider 1404, the adder 1405, the right shift operator 1406, and the remainder operators 1408 and 1410 may be implemented by related logic circuits and/or related computing algorithms, and the invention is not limited thereto. In the present embodiment, the divider 1404 may be an integer divider.

In the present embodiment, in order to calculate the first intermediate variable K1 and the second intermediate variable K2, the first processor 1141 may execute the following computing logic. The first processor 1141 may multiply the first input Din1 by the first parameter Reg1 via the multiplier 1401, and the first processor 1141 may multiply the second input Din2 by the second parameter Reg2 via the multiplier 1402. The first processor 1141 may perform a subtraction operation on the operation results of the multiplier 1401 and the multiplier 1402 via the subtractor 1403. Then, the first processor 1141 may divide the operation result of the subtractor 1403 by a seventh parameter Reg7 via the divider 1404. The first processor 1141 may add the operation result of the divider 1404 to 2 to the power of Q−1 via the adder 1405. The first processor 1141 may right shift the operation result of the adder 1405 by Q bits via the right shift operator 1406. Then, the first processor 1141 may multiply the operation result of the right shift operator 1406 by the third parameter Reg3 via the multiplier 1407, and perform a remainder operation on the operation result of the multiplier 1407 by using the fourth parameter Reg4 via the remainder operator 1408 to generate the first intermediate variable K1. Moreover, the first processor 1141 may multiply the operation result of the right shift operator 1406 by the fifth parameter Reg5 via the multiplier 1409, and perform a remainder operation on the operation result of the multiplier 1409 by using the sixth parameter Reg6 via the remainder operator 1410 to generate the second intermediate variable K2.

In the present embodiment, the values of the first parameter Reg1 to the sixth parameter Reg6 are as provided in the above description of the embodiment of FIG. 13A, and are not described again here. In the present embodiment, the seventh parameter Reg7 may be equal to the preset parameter B. In the present embodiment, the plurality of parameters Dreg stored in the parameter storage 1160 may include the first parameter Reg1 to the seventh parameter Reg7, the preset parameter B, the first preset parameter N1, and the second preset parameter M1 used in the present embodiment.

Moreover, the first intermediate variable K1 and the second intermediate variable K2 generated by the first processor 1141 of the present embodiment may be further provided to the computing logic of the second processor 1142 as shown in FIG. 13B to generate the first output Dout1 and the second output Dout2.

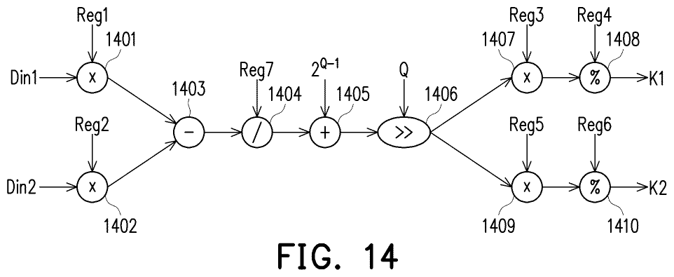

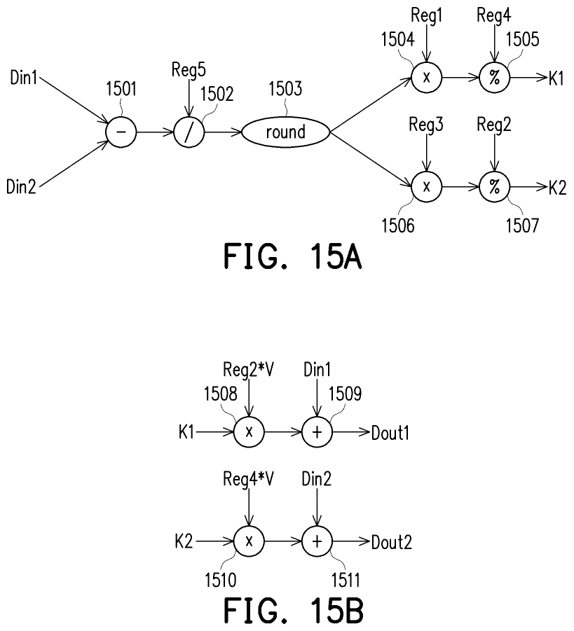

FIG. 15A is a schematic diagram of the operation logic of a first processor of an embodiment of the invention. FIG. 15B is a schematic diagram of the operation logic of a second processor of an embodiment of the invention. Referring to FIG. 11, FIG. 15A, and FIG. 15B, the present embodiment provides a computing logic suitable for performing a floating point operation. It should be noted that in the present embodiment, the first input Din1 and the second input Din2 may be depth information, and the first input Din1, the second input Din2, the first output Dout1, and the second output Dout2 may satisfy the following formula (3) and formula (4), wherein the preset parameter B and a preset parameter C may be determined according to system or sensor characteristics or set by the user.

$$D out 1 = K 1 \times B + Din 1 \qquad formula ( 3 )$$

$$D out 2 = K 2 \times C + Din 2 \qquad formula ( 4 )$$

Referring first to FIG. 11 and FIG. 15A, the first processor 1141 of FIG. 11 may perform a floating point operation and may implement the computing logic of FIG. 15A. In the present embodiment, the first processor 1141 may include a subtractor 1501, a divider 1502, a rounding operator 1503, multipliers 1504 and 1506, and remainder operators 1505 and 1507. The subtractor 1501, the divider 1502, the rounding operator 1503, the multipliers 1504 and 1506, and the remainder operators 1505 and 1507 may be implemented by related logic circuits and/or related computing algorithms, and the invention is not limited thereto.

In the present embodiment, in order to calculate the first intermediate variable K1 and the second intermediate variable K2, the first processor 1141 may execute the following computing logic. The first processor 1141 may subtract the second input Din1 from the first input Din1 via the subtractor 1501. The first processor 1141 may divide the computing result of the subtractor 1501 by the fifth parameter Reg5 via the divider 1502, and perform a rounding operation via the rounding operator 1503. Then, the first processor 1141 may multiply the operation result of the rounding operator 1503 by the first parameter Reg1 via the multiplier 1504, and perform a remainder operation on the operation result of the multiplier 1504 by using the fourth parameter Reg4 via the remainder operator 1505 to generate the first intermediate variable K1. The first processor 1141 may multiply the operation result of the rounding operator 1503 by the third parameter Reg3 via the multiplier 1506, and perform a remainder operation on the operation result of the multiplier 1506 by using the second parameter Reg2 via the remainder operator 1507 to generate the second intermediate variable K2.

In the present embodiment, the first parameter Reg1 and the third parameter Reg3 are predefined integers. The second parameter Reg2 is the predefined first preset parameter N2. The fourth parameter Reg4 is the predefined second preset parameter M2. The first preset parameter N2 and the second preset parameter M2 are co-prime. The fifth parameter Reg5 may be the greatest common divisor (GCD) of the preset parameter B and the preset parameter C. In the present embodiment, assuming that the fifth parameter Reg5 is equal to the preset parameter V, then the preset parameter B in formula (3) and formula (4) is equal to the result of the first preset parameter N2 multiplied by the preset parameter V (N2*V), and the preset parameter C is equal to the result of the first preset parameter M2 multiplied by the preset parameter V (M2*V). In the present embodiment, the plurality of parameters Dreg stored in the parameter storage 1160 may include the first parameter Reg1 to the fifth parameter Reg5, the preset parameter B, the first preset parameter N2, and the second preset parameter M2 used in the present embodiment.

Then, referring to FIG. 11 and FIG. 15B, the second processor 1142 of FIG. 11 may perform a floating point operation and may implement the computing logic of FIG. 15B. In the present embodiment, the second processor 1142 may include multipliers 1508 and 1510 and adders 1509 and 1511. The multipliers 1508 and 1510 and the adders 1509 and 1511 may be implemented by related logic circuits and/or related computing algorithms, and the invention is not limited thereto.

In the present embodiment, in order to calculate the first output Dout1 and the second output Dout2, the second processor 1142 may execute the following computing logic. The second processor 1142 may multiply the first intermediate variable K1 by the result of the second parameter Reg2 multiplied by the preset parameter V via the multiplier 1508 (Reg2 multiplied by V equals the preset parameter B), and add the operation result of the multiplier 1508 to the first input Din1 via the adder 1509 to obtain the first output Dout1. The second processor 1142 may multiply the second intermediate variable K2 by the result of the fourth parameter Reg4 multiplied by the preset parameter V via the multiplier 1510 (Reg4 multiplied by V equals the preset parameter C), and add the operation result of the multiplier 1510 to the second input Din2 via the adder 1511 to obtain the second output Dout2.

More specifically, the embodiments of FIG. 11, FIG. 15A, and FIG. 15B may be applied to time-of-flight dual frequency sensing (ToF dual frequency sensing). Accordingly, the time-of-flight ranging sensor may emit the first sensing light and the second sensing light to the sensing target according to two different modulation frequencies, wherein the preset parameter B and the preset parameter C may be the farthest detectable unambiguous distance of the first sensing light and the second sensing light respectively. The farthest detectable unambiguous distance (d1) of the first sensing light may be equal to the result of dividing the speed of light by twice the first modulation frequency (f1) (i.e., d1=c/(2×f1), wherein d1 is the farthest detectable unambiguous distance of the first sensing light, c is the speed of light, and f1 is the modulation frequency of the first sensing light). In this regard, formula (1) may unpack the first input Din1 to generate new depth information, that is, the first output Dout1. Moreover, formula (2) may unpack the second input Din2 to generate new depth information, that is, the second output Dout2. Moreover, the first output Dout1 and the second output Dout2 of the present embodiment are depth information, so there is no need to use the phase-to-distance converter 1170. The first output Dout1 may be equal to the first depth information Dist1, and the second output Dout2 may be equal to the second depth information Dist2. In this way, the fusion processor 150 of FIG. 1 may combine the first depth information Dist1 and the second depth information Dist2 via a fusion function (such as a weighted average operation function) to obtain accurate distance measurements.

For example, the following derivation uses simple numerical values as examples. In the absence of noise, it is assumed that the first input Din1 is equal to 1. The second input Din2 is equal to 3. The preset parameter B is equal to 4. The preset parameter C is equal to 5. Moreover, the first parameter Reg1 is 1 (precalculated and configured by the user or the system). The second parameter Reg2 is 4(B/V). The third parameter Reg3 is 1 (precalculated and configured by the user or the system). The fourth parameter Reg4 is 5(C/V). The fifth parameter Reg5 is 1 (V=GDC(4,5)). Therefore, the first processor 1141 may calculate the first intermediate variable K1 is equal to 1 (K1=round(1−3)×1%5=3), and may calculate the second intermediate variable K2 is equal to 2 (K2=round(1−3)×1%4=2). Moreover, the second processor 1142 may calculate the first output Dout1 is equal to 13 (Dout1=K1×B+Din1=3×4+1=13), and the second output Dout2 is equal to 13 (Dout2=K2×B+Din2−2×5+3=13).

As another example, the following derivation uses simple numerical values as examples. In the presence of noise, it is assumed that the first input Din1 is equal to 4.1. The second input Din2 is equal to 1.9. The preset parameter B is equal to 4. The preset parameter C is equal to 5. Moreover, the first parameter Reg1 is 1 (precalculated and configured by the user or the system). The second parameter Reg2 is 4(B/V). The third parameter Reg3 is 1 (precalculated and configured by the user or the system). The fourth parameter Reg4 is 5(C/V). The fifth parameter Reg5 is 1 (V=GDC(4,5)). Therefore, the first processor 1141 may calculate the first intermediate variable K1 is equal to 1 (K1=round(4.1−1.9)×1%5=2), and may calculate the second intermediate variable K2 is equal to 2 (K2=round(4.1−1.9)×1%4=2). Moreover, the second processor 1142 may calculate the first output Dout1 is equal to 12.0 (Dout1=K1×B+Din1=2×4+4.1=12.1), and the second output Dout2 is equal to 11.9 (Dout2=K2×C+Din2=2×5+1.9=11.9).

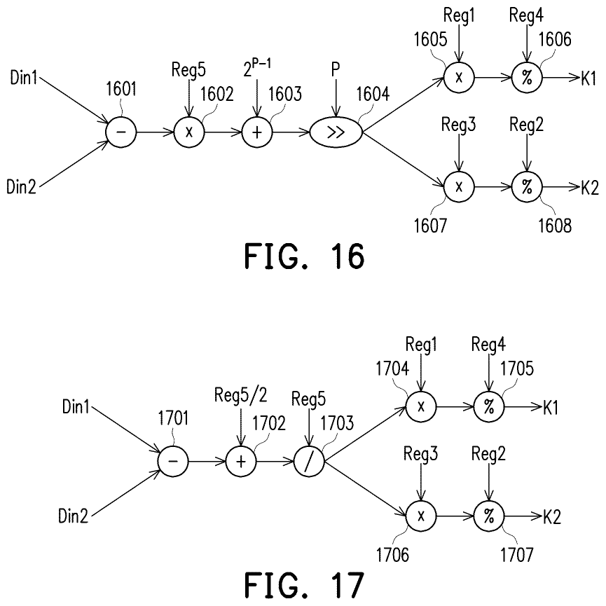

FIG. 16 is a schematic diagram of the operation logic of a first processor of an embodiment of the invention. Referring to FIG. 11 and FIG. 16, the present embodiment provides a computing logic suitable for performing fixed point computing. It should be noted first that in the present embodiment, the first input Din1 and the second input Din2 may be depth information, and the first input Din1, the second input Din2, the first output Dout1, and the second output Dout2 may satisfy formula (3) and formula (4).

Referring first to FIG. 11 and FIG. 16, the first processor 1141 of FIG. 11 may perform a fixed point operation and may implement the computing logic of FIG. 16. In the present embodiment, the first processor 1141 may include a subtractor 1601, multipliers 1602, 1605, 1607, an adder 1604, a right shift operator 1604, and remainder operators 1606 and 1608. The subtractor 1601, the multipliers 1602, 1605, and 1607, the adder 1603, the right shift operator 1604, and the remainder operators 1606 and 1608 may be implemented by related logic circuits and/or related computing algorithms, and the invention is not limited thereto.

In the present embodiment, in order to calculate the first intermediate variable K1 and the second intermediate variable K2, the first processor 1141 may execute the following computing logic. The first processor 1141 may subtract the first input Din1 and the second input Din2 via the subtractor 1601, and the first processor 1141 may multiply the operation result of the subtractor 1601 by the fifth parameter Reg5 via the multiplier 1602. The first processor 1141 may add the operation result of the multiplier 1602 to 2 to the power of P−1 via the adder 1603, and the first processor 1141 may right shift the operation result of the adder 1603 by P bits via the right shift operator 1604. Then, the first processor 1141 may multiply the operation result of the right shift operator 1604 by the first parameter Reg1 via the multiplier 1605, and the first processor 1141 may perform a remainder operation on the operation result of the multiplier 1605 by using the fourth parameter Reg4 via the remainder operator 1606 to generate the first intermediate variable K1. The first processor 1141 may multiply the operation result of the right shift operator 1604 by the third parameter Reg3 via the multiplier 1607, and the first processor 1141 may perform a remainder operation on the operation result of the multiplier 1607 by using the second parameter Reg2 via the remainder operator 1608 to generate the second intermediate variable K2.

In the present embodiment, the values of the first parameter Reg1 to the fourth parameter Reg4 are as provided in the above description of the embodiment of FIG. 15A, and are not described again here. In the present embodiment, the fifth parameter Reg5 may be the result of dividing 2 to the power of P by the preset parameter V and performing a rounding operation (Reg5=round(2^{P}/V)), and 2 to the power of P is significantly greater than the preset parameter V. In the present embodiment, the plurality of parameters Dreg stored in the parameter storage 1160 may include the first parameter Reg1 to the fifth parameter to Reg5 used in the present embodiment.

Moreover, the first intermediate variable K1 and the second intermediate variable K2 generated by the first processor 1141 of the present embodiment may be further provided to the computing logic of the second processor 1142 as shown in FIG. 15B to generate the first output Dout1 and the second output Dout2.

FIG. 17 is a schematic diagram of the operation logic of a first processor of an embodiment of the invention. Referring to FIG. 11 and FIG. 17, the present embodiment provides another computing logic suitable for performing fixed point computing. Accordingly, the first processor 1141 of FIG. 11 may perform a fixed point operation and may implement the computing logic of FIG. 17. In the present embodiment, the first processor 1141 may include a subtractor 1701, an adder 1702, a divider 1703, multipliers 1704 and 1706, and remainder operators 1705 and 1707. The subtractor 1701, the adder 1702, the divider 1703, the multipliers 1704 and 1706, and the remainder operators 1705 and 1707 may be implemented by related logic circuits and/or related computing algorithms, and the invention is not limited thereto.

In the present embodiment, in order to calculate the first intermediate variable K1 and the second intermediate variable K2, the first processor 1141 may execute the following computing logic. The first processor 1141 may subtract the first input Din1 and the second input Din2 via the subtractor 1701, and the first processor 1141 may add the operation result of the subtractor 1701 to the result of dividing the fifth parameter Reg5 by 2 via the adder 1702. The first processor 1141 may divide the operation result of the adder 1702 by the fifth parameter Reg5 via the divider 1703. Then, the first processor 1141 may multiply the operation result of the divider 1703 by the first parameter Reg1 via the multiplier 1704, and the first processor 1141 may perform a remainder operation on the operation result of the multiplier 1704 by using the fourth parameter Reg4 via the remainder operator 1705 to generate the first intermediate variable K1. The first processor 1141 may multiply the operation result of the divider 1703 by the third parameter Reg3 via the multiplier 1706, and the first processor 1141 may perform a remainder operation on the operation result of the multiplier 1706 by using the second parameter Reg2 via the remainder operator 1707 to generate the second intermediate variable K2.

In the present embodiment, the values of the first parameter Reg1 to the fourth parameter Reg4 are as provided in the above description of the embodiment of FIG. 15A, and are not described again here. In the present embodiment, the fifth parameter Reg5 may be equal to the preset parameter V. In the present embodiment, the plurality of parameters Dreg stored in the parameter storage 1160 may include the first parameter Reg1 to the fifth parameter to Reg5 used in the present embodiment.

Moreover, for the computing processor 140 of FIG. 1, in an embodiment, the numerical relationships and specific numerical values of the first input Din1, the second input Din2, the first output Dout1, the second output Dout2 corresponding to the first reflected light and the second reflected light of different modulation frequencies, as well as the plurality of parameters above may also be pre-calculated and counted to create a lookup table. In this way, the computing processor 140 of FIG. 1 may not have the relevant computing logic, and may directly search the lookup table according to the first input Din1, the second input Din2, and the plurality of parameters above to quickly generate the first output Dout1 and the second output Dout2.

In another embodiment, for the computing processor 1140 of FIG. 11, the first processor 1141 and/or the second processor 1142 may establish a lookup table. The first processor 1141 may directly search the lookup table according to the first input Din1, the second input Din2, and the plurality of parameters to quickly generate the first intermediate variable K1 and the second intermediate variable K2. The second processor 1142 may directly search the lookup table according to the first input Din1, the second input Din2, the first intermediate variable K1, and the second intermediate variable K2 to quickly generate the first output Dout1 and the second output Dout2.

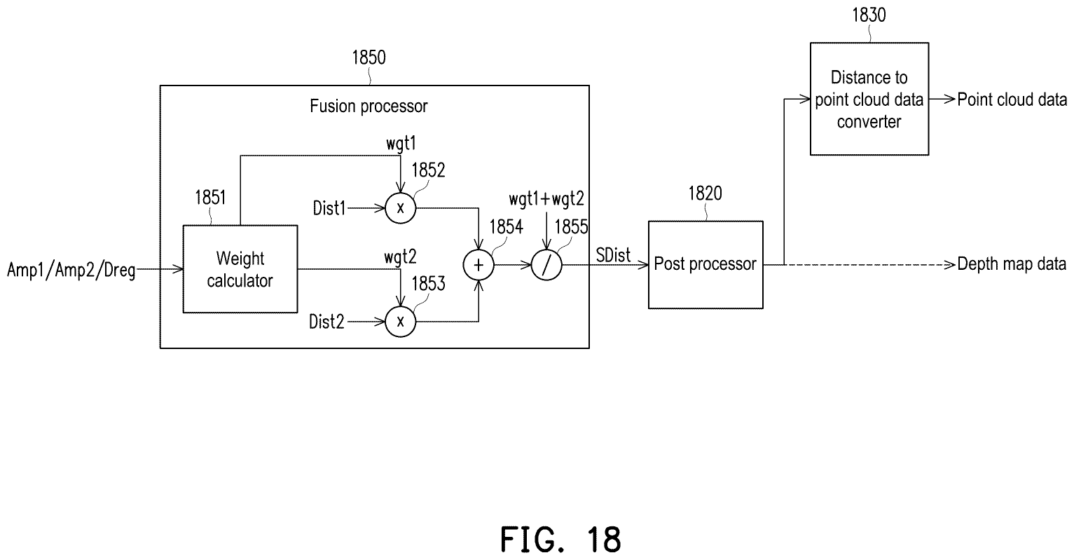

FIG. 18 is a schematic diagram of a fusion processor of an embodiment of the invention. Referring to FIG. 18, the fusion processor 150 of FIG. 1 may be implemented by the architecture of the fusion processor 1850 of FIG. 18. In the present embodiment, the fusion processor 1850 may perform a weighted average operation to generate the depth information SDist. Specifically, the fusion processor 1850 includes a weight calculator 1851, multipliers 1852 and 1853, an adder 1854, and a divider 1855. In the present embodiment, the weight calculator 1851 may generate first weight data wgt1 and second weight data wgt2 according to the first amplitude Amp1, the second amplitude Amp2, and the plurality of parameters Dreg. The fusion processor 1850 may multiply the first depth information Dist1 and the first weight data wgt1 generated by the above embodiments via the multiplier 1852, for example, and the fusion processor 1850 may multiply the second depth information Dist2 and the second weight data wgt2 generated by the above embodiments via the multiplier 1853, for example. Then, the fusion processor 1850 may add the computing results of the multiplier 1852 and the multiplier 1853 via the adder 1854, and the fusion processor 1850 may divide the computing result of the adder 1854 by the addition result of the first weight data wgt1 and the second weight data wgt2 via the divider 1855 to generate the depth information SDist.

In the present embodiment, the fusion processor 1850 may output the depth information SDist to the post-processor 1820 so that the post-processor 1820 may generate, for example, depth map data according to the depth information SDist, or provide the depth information SDist to the distance to point cloud data converter 1830 to generate point cloud data, etc., but the invention is not limited thereto.

Based on the above, the time-of-flight ranging system and the time-of-flight ranging method of the invention may temporarily store at least a portion of the raw data output by the time-of-flight ranging sensor by using the memory space of the memory, so that the decoder may match the corresponding pixel clock to efficiently read the raw data so as to efficiently convert the raw data into corresponding phase parameters for subsequent use by the computing processor. Moreover, in the time-of-flight ranging system and the time-of-flight ranging method of the invention, specific computing logic or lookup tables may be executed via the computing processor to generate the depth information correctly and efficiently.

Although the invention has been described with reference to the above embodiments, it will be apparent to one of ordinary skill in the art that modifications to the described embodiments may be made without departing from the spirit of the invention. Accordingly, the scope of the invention is defined by the attached claims not by the above detailed descriptions.

What is claimed is:

1. A time-of-flight ranging system, comprising:
a time-of-flight ranging sensor configured to receive a first reflected light and a second reflected light reflected by a sensing target, and generate first raw data and second raw data according to the first reflected light;
a decoder coupled to the time-of-flight ranging sensor and configured to generate a first input according to the first raw data and generate a second input according to the second raw data;
a computing processor coupled to the decoder and configured to generate a first output and a second output according to the first input and the second input; and
a fusion processor coupled to the computing processor and configured to perform a weighted average operation according to a first amplitude, a second amplitude, the first output, and the second output to generate depth information.

2. The time-of-flight ranging system of claim 1, wherein the time-of-flight ranging system further comprises:
a memory coupled to the time-of-flight ranging sensor and the decoder and configured to temporarily store at least one of a plurality of phase sampling data of the first raw data and the second raw data respectively.

3. The time-of-flight ranging system of claim 2, wherein the time-of-flight ranging sensor first temporarily stores at least one of the phase sampling data of the first raw data into a plurality of memory spaces of the memory, then the time-of-flight ranging sensor provides at least another one of the phase sampling data of the first raw data directly to the decoder, and the decoder reads at least one of the phase sampling data from the memory to generate the first input,
wherein the time-of-flight ranging sensor then first temporarily stores at least one of the phase sampling data of the second raw data into the memory spaces of the memory, then the time-of-flight ranging sensor provides at least another one of the phase sampling data of the second raw data directly to the decoder, and the decoder reads at least one of the phase sampling data from the memory to generate the second input.

4. The time-of-flight ranging system of claim 2, wherein the memory comprises a first set of memory space and a second set of memory space,
wherein the time-of-flight ranging sensor sequentially temporarily stores the phase sampling data of the first raw data and the second raw data respectively into the first set of memory space and the second set of memory space of the memory.

5. The time-of-flight ranging system of claim 4, wherein the decoder reads the phase sampling data of the first raw data from the first set of memory space to generate the first input, and then reads the phase sampling data of the second raw data from the second set of memory space to generate the second input.

6. The time-of-flight ranging system of claim 4, wherein the decoder reads the phase sampling data of the first raw data from the first set of memory space to generate the first input, and another decoder reads the phase sampling data of the second raw data from the second set of memory space to generate the second input at the same time.

7. The time-of-flight ranging system of claim 6, wherein the memory also comprises a third set of memory space and a fourth set of memory space, and during a period in which the phase sampling data temporarily stored in the first set of memory space and the second set of memory space are read out, the time-of-flight ranging sensor sequentially temporarily stores a plurality of phase sampling data respectively of third raw data and fourth raw data into the third set of memory space and the fourth set of memory space of the memory.

8. The time-of-flight ranging system of claim 7, wherein the decoder reads the phase sampling data of the first raw data from the first set of memory space at a plurality of odd pixel clocks, and reads the phase sampling data of the second raw data from the second set of memory space at a plurality of even pixel clocks to generate the first input and the second input.

9. The time-of-flight ranging system of claim 1, wherein the computing processor comprises:
a first processor coupled to the decoder and configured to generate a first intermediate variable and a second intermediate variable according to a plurality of parameters, the first input, and the second input; and
a second processor coupled to the first processor and configured to generate the first output and the second output according to the first input, the second input, the first intermediate variable, and the second intermediate variable.

10. The time-of-flight ranging system of claim 9, wherein the first processor multiplies the first input by a first parameter minus the second input multiplied by a second parameter, then performs a rounding operation and multiplied by a third parameter, and lastly performs a remainder operation by using a fourth parameter to generate the first intermediate variable,
wherein the first processor multiplies the first input by the first parameter minus the second input multiplied by the second parameter, then performs a rounding operation and multiplied by a fifth parameter, and lastly performs a remainder operation by using a sixth parameter to generate the second intermediate variable,
wherein the first parameter is a result of dividing a first preset parameter by a preset parameter, and the second parameter is a result of dividing a second preset parameter by the preset parameter, wherein the preset parameter is 2π.

11. The time-of-flight ranging system of claim 10, wherein the fourth parameter is the second preset parameter, and the sixth parameter is the first preset parameter,
wherein the third parameter is an integer value satisfying the first preset parameter multiplied by another integer value and added by 1 and then divided by the second preset parameter or a result thereof,
wherein the fifth parameter is a rounded down result of the third parameter multiplied by the second preset parameter and divided by the first preset parameter.

12. The time-of-flight ranging system of claim 10, wherein the second processor multiplies the first intermediate variable by the preset parameter then adds the first input to obtain the first output, and the second processor multiplies the second intermediate variable by the preset parameter then adds the second input to obtain the second output.

13. The time-of-flight ranging system of claim 9, wherein the first processor multiplies the first input by a first parameter, subtracts the second input multiplied by a second parameter, and adds 2 to a power of P−1, and right shifts a numerical result by P bits, and then multiplied by a third parameter and performs a remainder operation by using a fourth parameter to generate the first intermediate variable, wherein P is a precision factor,
wherein the first processor multiplies the first input by the first parameter, subtracts the second input multiplied by the second parameter, and adds 2 to the power of P−1, and right shifts a numerical result by P bits, then multiplied by a fifth parameter and performs a remainder operation by using a sixth parameter to generate the second intermediate variable,
wherein the first parameter is a result of 2 to a power of Q multiplied by a first preset parameter, divided by a preset parameter and then subjected to a rounding operation,
wherein the second parameter is a result of 2 to the power of Q multiplied by a second preset parameter, divided by the preset parameter and then subjected to a rounding operation,
wherein P is equal to a result of Q plus one input precision, and P and Q are positive integers.

14. The time-of-flight ranging system of claim 13, wherein the second processor multiplies the first intermediate variable by a rounding operation result of the preset parameter multiplied by 2 to a power S to obtain the first output, and the second processor multiplies the second intermediate variable by a rounding operation result of the preset parameter multiplied by 2 to the power S to obtain the second output, wherein S is a positive integer.

15. The time-of-flight ranging system of claim 9, wherein the first processor subtracts the second input from the first input then divided by a fifth parameter and performs rounding, and then multiplied by a first parameter and performs a remainder operation by using a fourth parameter to generate the first intermediate variable,
wherein the first processor subtracts the second input from the first input then divided by the fifth parameter and performs rounding, and then multiplied by a third parameter and performs a remainder operation by using a second parameter to generate the second intermediate variable,
wherein the first parameter and the third parameter are respectively integers, and the second parameter and the fourth parameter are respectively co-prime preset parameters,
wherein the fifth parameter is a greatest common factor of the second parameter and the fourth parameter.

16. The time-of-flight ranging system of claim 15, wherein the second processor multiplies the first intermediate variable by the second parameter, multiplies a preset parameter, and adds the first input to generate the first output,
wherein the second processor multiplies the second intermediate variable by the fourth parameter, multiplies the preset parameter, and adds the second input to generate the second output.

17. The time-of-flight ranging system of claim 9, wherein the first processor subtracts the first input and the second input, multiplied by a fifth parameter, adds 2 to a power of P−1, and right shifts a numerical result by P bits, and then multiplied by a first parameter and performs a remainder operation by using a fourth parameter to generate the first intermediate variable, wherein P is a positive integer,
wherein the first processor subtracts the first input and the second input, multiplied by the fifth parameter, adds 2 to the power of P−1, and right shifts a numerical result by P bits, and then multiplied by a third parameter and performs a remainder operation by using a second parameter to generate the second intermediate variable,
wherein the first parameter and the third parameter are respectively integers, and the second parameter and the fourth parameter are respectively co-prime preset parameters,
wherein the fifth parameter is a result of performing a remainder operation of 2 to a power of P by using a preset parameter, and 2 to the power of P is significantly greater than the preset parameter.

18. The time-of-flight ranging system of claim 9, wherein the time-of-flight ranging sensor is an indirect time-of-flight ranging sensor, and the first reflected light and the second reflected light have different modulation frequencies.

19. The time-of-flight ranging system of claim 1, wherein the computing processor is configured to generate a lookup table according to the first input, the second input, and a plurality of parameters and generates the first output and the second output by searching a lookup table.

20. A time-of-flight ranging method, comprising:
receiving a first reflected light and a second reflected light reflected by a sensing target and generating first raw data and second raw data according to the first reflected light via a time-of-flight ranging sensor;
generating a first input according to the first raw data and generating a second input according to the second raw data via a decoder;
generating a first output and a second output according to the first input and the second input via a computing processor; and
performing a weighted average operation according to a first amplitude, a second amplitude, the first output, and the second output via a fusion processor to generate depth information.
